(19) United States
(12) Patent Application Publication
(10) Pub. No.: US 2012/0258706 A1
(43) Pub. Date: Oct. 11, 2012

(54) Apparatus, Method and Article of Manufacture

(76) Inventors: Ling Yu, Oulu (FI); Vinh Van Phan, Oulu (FI); Kari Veikko Horneman, Oulu (FI); Kari Juhani Hooli, Oulu (FI)

(21) Appl. No.: 13/260,420

(22) PCT Filed: Mar. 27, 2009
(86) PCT No.: PCT/EP09/53673

§ 371 Date: Jun. 15, 2012

(51) Int. Cl. H04W 56/00; H04W 88/06

(52) U.S. Cl. 455/426.1; 455/552.1

(57) ABSTRACT

There is provided an apparatus including a receiver configured to receive a signal from a transmitting terminal via a direct device-to-device communication connection, and to receive a cellular reference signal from a cellular network; a processor configured to measure a time difference between the received signal and the cellular reference signal; and a transmitter configured to transmit the result of the measured time difference to the transmitting terminal for adjusting device-to-device transmission timing of the transmitting terminal.

### FIELD OF THE INVENTION

The exemplary and non-limiting embodiments of this invention relate generally to an apparatus, a method and an article of manufacture.

### BACKGROUND OF THE INVENTION

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

This invention is related to direct device-to-device (D2D), mobile-to-mobile (M2M), terminal-to-terminal (T2T) and peer-to-peer (P2P) communications integrated into a cellular network, such as a network targeted for 3GPP LTE systems and evolution thereof, also referred to as LTE-Advanced (LTE-A). The integration means that devices (or mobiles or terminals or peers or machines) having a direct D2D physical radio link may use radio resources of a cellular network and thus share the resources with devices being connected to the cellular network using a conventional radio link via a node B (NB), also referred to as a base station (BS).

Examples of reasons for incorporating direct D2D communications into a cellular network are, among various aspects, to reduce transmitter power consumption in both the device and the network side, to increase cellular network capacity and coverage, and to create and support more services for the users in the most efficient fashion.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented below.

Various aspects of the invention comprise a method, an apparatus, and an article of manufacture comprising a computer readable medium as defined in the independent claims. Further embodiments of the invention are disclosed in the dependent claims.

According to an aspect of the invention, there are provided apparatuses as specified in claims 1, 8 and 22.

According to an aspect of the invention, there are provided methods as specified in claims 11 and 18.

According to an aspect of the invention, there is provided an article of manufacture comprising a computer readable medium as specified in claim 20.

An aspect of the invention relates to a method comprising: receiving a signal from a transmitting terminal via a direct device-to-device communication connection, and receiving a cellular reference signal from a cellular network; measuring a time difference between the received signal and the cellular reference signal; and transmitting the result of the measured time difference to the transmitting terminal for adjusting device-to-device transmission timing of the transmitting terminal.

A further aspect of the invention relates to a method comprising: transmitting a signal to a receiving terminal via a direct device-to-device communication connection for enabling the receiving terminal to measure a time difference between the transmitted signal and a cellular reference signal of a cellular network; receiving the result of the measured time difference from the receiving terminal; and adjusting device-to-device transmission timing of the apparatus on the basis of the received result of the measured time difference.

A further aspect of the invention relates to an apparatus comprising: a receiver configured to receive a signal from a transmitting terminal via a direct device-to-device communication connection, and to receive a cellular reference signal from a cellular network; a processor configured to measure a time difference between the received signal and the cellular reference signal; and a transmitter configured to transmit the result of the measured time difference to the transmitting terminal for adjusting device-to-device transmission timing of the transmitting terminal.

A still further aspect of the invention relates to an apparatus comprising: a transmitter configured to transmit a signal to a receiving terminal via a direct device-to-device communication connection for enabling the receiving terminal to measure a time difference between the transmitted signal and a cellular reference signal of a cellular network; a receiver configured to receive the result of the measured time difference from the receiving terminal; and a processor configured to adjust device-to-device transmission timing of the apparatus on the basis of the received result of the measured time difference.

A still further aspect of the invention relates to an apparatus comprising: a processor configured to perform a pairing process of a first terminal and a second terminal for a direct device-to-device communication connection; a receiver configured to receive from the first terminal a result of a measured time difference between a signal from the second terminal and a cellular reference signal from a cellular network; and a transmitter configured to transmit the result of the measured time difference to the second terminal for adjusting device-to-device transmission timing of the second terminal.

A still further aspect of the invention relates to an article of manufacture, comprising a computer readable medium and embodying program instructions thereon, executable by a computer operably coupled to a memory and, when executed by the computer, carry out the functions of: receiving a signal from a transmitting terminal via a direct device-to-device communication connection, and receiving a cellular reference signal from a cellular network; measuring a time difference between the received signal and the cellular reference signal; and transmitting the result of the measured time difference to the transmitting terminal for adjusting device-to-device transmission timing of the transmitting terminal.

Although the various aspects, embodiments and features of the invention are recited independently, it should be appreciated that all combinations of the various aspects, embodiments and features of the invention are possible and within the scope of the present invention as claimed.

### BRIEF DESCRIPTION OF THE DRAWINGS

In the following the invention will be described in greater detail by means of exemplary embodiments and with reference to the attached drawings, in which

FIG. 1 shows a simplified block diagram illustrating a exemplary system architecture;

FIG. 2 shows a simplified block diagram illustrating examples of apparatuses that are suitable for use in practising the exemplary embodiments of the invention;

FIG. 3 shows a messaging diagram illustrating an exemplary messaging event according to an embodiment of the invention;

FIG. 4 shows another messaging diagram illustrating another exemplary event according to an embodiment of the invention; and

FIGS. 5, 6 and 7 show examples of methods according to embodiments of the invention.

### DETAILED DESCRIPTION OF THE INVENTION

Exemplary embodiments of the present invention will now be described in more detail with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention is applicable to any user terminal, server, corresponding component, and/or to any communication system or any combination of different communication systems. The communication system may be a fixed communication system or a mobile communication system or a communication system utilizing both fixed networks and mobile networks. The used protocols, the specifications of communication systems, servers and user terminals, especially in wireless communication, develop rapidly. Such a development may require extra changes to an embodiment. Therefore, all words and expressions should be interpreted broadly and they are intended to illustrate, not to restrict, the embodiment.

In the following, different embodiments will be described using, as an example of a system architecture whereto the embodiments may be applied, an architecture based on LTE/SAE (Long Term Evolution/System Architecture Evolution) network elements without, however, restricting the embodiment to such an architecture.

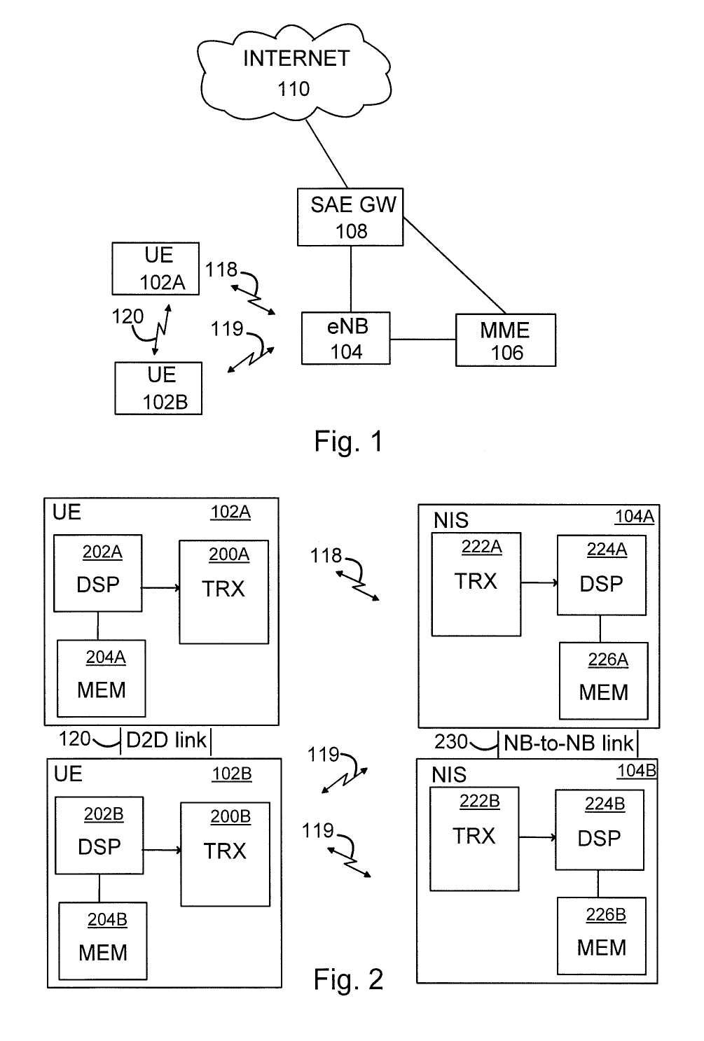

With reference to FIG. 1, let us examine an example of a radio system to which embodiments of the invention can be applied. In this example, the radio system is based on LTE/SAE (Long Term Evolution/System Architecture Evolution) network elements. However, the invention described in these examples is not limited to the LTE/SAE radio systems but can also be implemented in other radio systems, such as WIMAX (Worldwide Interoperability for Microwave Access), or in other suitable radio systems.

A general architecture of a radio system is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication are irrelevant to the actual invention. Therefore, they need not be discussed in more detail here.

The exemplary radio system of FIG. 1 comprises a service core of an operator including the following elements: an MME (Mobility Management Entity) 106 and an SAE GW (SAE Gateway) 108.

Base stations that may also be called eNBs (Enhanced node Bs) 104 of the radio system host the functions for Radio Resource Management: Radio Bearer Control, Radio Admission Control, Connection Mobility Control, Dynamic Resource Allocation (scheduling). The MME 106 is responsible for distributing paging messages to the eNBs 104.

User equipment (UE) 102A, 102B which may also be called (mobile) terminals may communicate with one or more base stations 104 using signals 118, 119. Signals 118, 119 between the UE 102A, 102B and the base station 104 carry digitized information, which is e.g. traffic data or control data.

The calls/services may be “long distance” where user traffic passes via the SAE GW 108. For example, a connection from the UE 102A, 102B to an external IP network, such as to the Internet 110, may be guided via the SAE GW 108. However, also local calls/services are possible in the exemplary radio system.

Each base station 104 of the radio system broadcasts a signal that may be a pilot signal such that the UE 102A, 102B can observe a potential base station to serve the UE 102A, 102B. Based on the pilot signals, the mobile terminal selects a base station with which to start a communication when switched on or on which to perform a handoff during normal operation. The UEs 102A and 102B may have a cellular connection via different base stations when the UEs 102A, 102B are located in different cells.

The UE 102A and the UE 102B may also communicate with each other by a direct D2D communication link 120 in addition to using a conventional radio link via a base station. It is also possible that the radio system may be operating in FDD (frequency division duplex) duplex mode and the direct D2D connections thereof are operating in TDD (time division duplex) duplex mode utilizing either cellular network uplink, downlink or uplink and downlink resources under the control of base stations. The radio system may be an FDD or TDD cellular network and the direct D2D communication connection may utilize either FDD or TDD duplexing.

Though clear motivation of incorporating a direct D2D communication into a cellular network exists, there are many technical issues to be solved or improved in order to make the system work. Some of these technical issues include D2D and cellular mode selection/reselection, D2D connection management and control (e.g. D2D link synchronization, power control etc.), interworking of a cellular system and D2D links, cellular network controlled resource allocation and scheduling.

Before further discussing exemplary embodiments of the invention, reference is made to FIG. 2 that shows a simplified block diagram illustrating examples of apparatuses that are suitable for use in practising the exemplary embodiments of the invention.

In FIG. 2, a wireless network is adapted to communication with the UEs 102A, 102B via at least one eNB 104A, 104B. Although the apparatuses 102A, 102B, 104A, 104B have been depicted as single entities, different modules and memory may be implemented in one or more physical or logical entities. In an embodiment, the UE 102A is configured to receive a signal from a transmitting terminal, here the UE 102B, via a direct device-to-device communication connection 120, and to receive a cellular reference signal from a cellular network 104A, to measure a time difference between the received signal and the cellular reference signal, and to transmit the result of the measured time difference to the transmitting terminal 102B for adjusting the device-to-device transmission timing of the transmitting terminal.

The UE 102B is configured to transmit a signal to a receiving terminal, here the UE 102A, via a direct device-to-device communication connection 120 for enabling the receiving terminal 102A to measure a time difference between the transmitted signal and a cellular reference signal of a cellular network, to receive the result of the measured time difference from the receiving terminal 102A, and to adjust the device-to-device transmission timing of the UE 102B on the basis of the received result of the measured time difference.

For these purposes, the UE 102A and the UE 102B each comprise a processor 202A, 202B and a communication unit 200A, 200B, e.g. a transmitter-receiver, for transmitting and receiving different outputs, information and messages. The UE 102A, 102B may also include a memory 204A, 204B for storing control information at least temporarily. The memory 204A, 204B may store computer program code such as software applications (for example for the detection device) or operating systems, information, data, content, or the like for the processor 202A, 202B to perform steps associated with the operation of the apparatus in accordance with the embodiments.

In the illustrated embodiment, the memory 204A, 204B stores instructions on how to perform: receiving a signal from a transmitting terminal via a direct device-to-device communication connection, and receiving a cellular reference signal from a cellular network; measuring a time difference between the received signal and the cellular reference signal; and transmitting the result of the measured time difference to the transmitting terminal for adjusting the device-to-device transmission timing of the transmitting terminal. In another embodiment, the memory 204A, 204B stores instructions on how to perform: transmitting a signal to a receiving terminal via a direct device-to-device communication connection for enabling the receiving terminal to measure a time difference between the transmitted signal and a cellular reference signal of a cellular network; receiving the result of the measured time difference from the receiving terminal; and adjusting the device-to-device transmission timing of the apparatus on the basis of the received result of the measured time difference. The memory may be, for example, random access memory (RAM), a hard drive, or other fixed data memory or storage device. Further, the memory, or part of it, may be a removable memory detachably connected to the apparatus.

The communication unit 200A, 200B is configured to communicate with the apparatus 104A and/or 104B that may be a part of one or more base stations of a cellular network. The user equipment 102A, 102B may also be a user terminal which is a piece of equipment or a device that associates, or is arranged to associate, the user terminal and its user with a subscription and allows the user to interact with a communications system. The user terminal presents information to the user and allows the user to input information. In other words, the user terminal may be any terminal capable of receiving information from and/or transmitting information to the network, connectable to the network wirelessly or via a fixed connection. Examples of a user terminal include a personal computer, game console, laptop (notebook), personal digital assistant, mobile station (mobile phone), and line telephone. The processor 202A, 202B is typically implemented with a microprocessor, a signal processor or separate components and associated software.

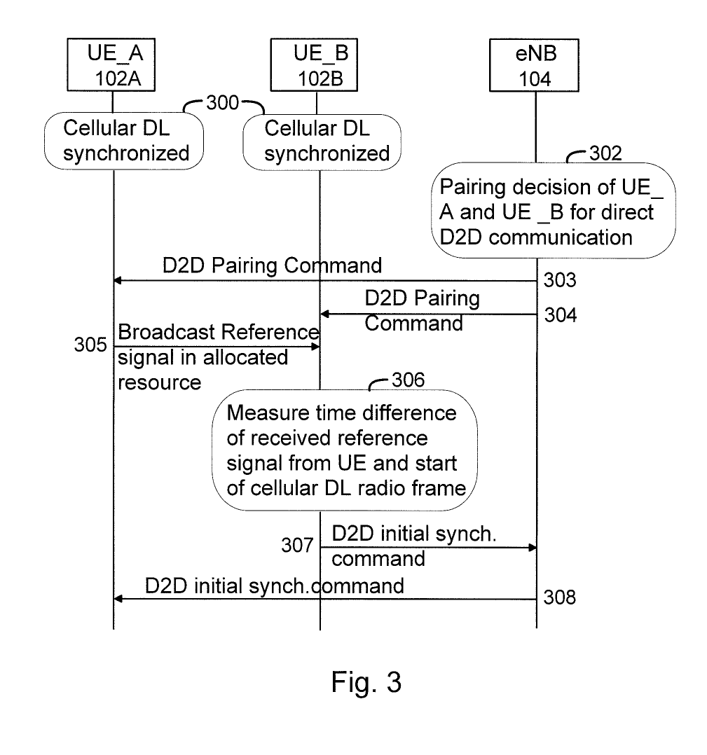

The functionality of the processor 202A, 202B, 224A is described in more detail below in FIGS. 3 to 7. It should be appreciated that the apparatus may also comprise other different units. However, they are irrelevant to the actual invention and, therefore, they need not be discussed in more detail here.

The apparatus 104A, 104B may be any network node or a host which is able to provide the necessary functionality of at least some of the embodiments. The apparatus 104A, 104B may be a network entity of a radio system, such as an entity that is a part of a base station. It is also possible that the different modules of the apparatus reside in different network entities of the system.

The apparatus 104A, 104B may generally include a processor 224A, 224B, controller, control unit or the like connected to a memory 226A, 226B and to various interfaces 222A, 222B of the apparatus. Generally the processor 224A, 224B is a central processing unit, but the processor may be an additional operation processor. The processor may comprise a computer processor, application-specific integrated circuit (ASIC), field-programmable gate array (FPGA), and/or other hardware components that have been programmed to carry out one or more functions of an embodiment.

The apparatus 104A, 104B may include a memory 226A, 226B comprising volatile and/or non-volatile memory, and it typically stores content, data, or the like. For example, the memory may store computer program code such as software applications or operating systems, information, data, content, or the like for the processor 224A, 224B to perform the steps associated with the operation of the apparatus in accordance with the embodiments. In the illustrated embodiment, the memory stores instructions on how to perform a pairing process of a first terminal and a second terminal (here the UEs 102A and 102B) for a direct device-to-device communication connection, to receive from the first terminal (UE102A) a result of a measured time difference between a signal from the second terminal (UE 102B) and a cellular reference signal from a cellular network, and to transmit the result of the measured time difference to the second terminal (UE102B) for adjusting the device-to-device transmission timing of the second terminal. The memory 226A, 226B may be, for example, random access memory (RAM), a hard drive, or other fixed data memory or storage device. Further, the memory, or part of it, may be removable memory detachably connected to the apparatus.

The techniques described herein may be implemented by various means so that an apparatus implementing one or more functions described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules), or combinations thereof. For firmware or software, the implementation can be through modules (e.g. procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer, or external to the processor/computer, in which case it can be communicatively coupled to the processor/computer via various means, as is known in the art.

The programming, such as an executable code or instructions (e.g. software or firmware), electronic data, databases, or other digital information, can be stored into memories, and it may include processor-usable media. Processor-usable media may be embodied in any computer program product or article of manufacture which can contain, store, or maintain programming, data or digital information for use by or in connection with an instruction execution system including the processor 202A, 202B, 224A, 224B in the exemplary embodiment. For example, exemplary processor-usable media may include any one of physical media, such as electronic, magnetic, optical, electromagnetic, and infrared or semiconductor media. Some more specific examples of processor-usable media include, but are not limited to, a portable magnetic computer diskette, such as a floppy diskette, zip disk, hard drive, random-access memory, read only memory, flash memory, cache memory, or other configurations capable of storing programming, data, or other digital information.

At least some embodiments or aspects described herein may be implemented using programming stored within an appropriate memory described above, or communicated via a network or other transmission media and configured to control an appropriate processor. For example, programming may be provided via appropriate media including, for example, embodied within articles of manufacture, embodied within a data signal (e.g. a modulated carrier wave, data packets, digital representations, etc.) communicated via an appropriate transmission medium, such as a communication network (e.g. the Internet or a private network), wired electrical connection, optical connection or electromagnetic energy, for example, via a communications interface, or it may be provided using another appropriate communication structure or medium. Exemplary programming including a processor-usable code may be communicated as a data signal embodied in a carrier wave.

In an embodiment, the processor 202A is configured to control initial link synchronization of the direct device-to-device communication connection to the transmitting terminal 102B on the basis of the measured time difference between the received signal from transmitting terminal and the cellular reference signal.

In an embodiment, the cellular reference signal is a cellular downlink reference signal that is used as a cellular synchronization reference signal for the initial synchronization of the direct device-to-device communication connection.

In an embodiment, the received signal from the transmitting terminal is a dedicated reference signal that is allocated to the transmitting terminal and used for the initial synchronization of the direct device-to-device communication connection.

In an embodiment, the received signal from the transmitting terminal is a cellular uplink reference signal. In an embodiment, the received signal from the transmitting terminal is a cellular uplink reference signal that is allocated to the transmitting terminal for another cellular uplink control purpose and used as well for the initial synchronization of the direct device-to-device communication connection.

In an embodiment, the processor 202A is further configured to maintain link synchronization of the direct device-to-device communication connection to the transmitting terminal 1028 on the basis of the measured time difference between the received signal from transmitting terminal and the cellular reference signal.

In an embodiment, the received signal from the transmitting terminal is any device-to-device signal from the transmitting terminal.

In an embodiment, the processor 202A is configured to measure the time difference between the received direct device-to-device signal and the cellular reference signal.

In an embodiment, the receiver 200B is configured to receive the result of the measured time difference from the receiving terminal 102A for maintaining link synchronization of the direct device-to-device communication connection, and the processor 202B is configured to adjust the device-to-device transmission timing on the basis of the received result of the measured time difference.

In an embodiment, the processor 202B is further configured to measure a cellular downlink timing offset of two neighbouring cells, and to take the measured cellular downlink timing offset into account when sending the signal to the receiving terminal 102A.

In an embodiment, the receiver 222A (e.g. in the node B 104A) is configured to receive a measured cellular downlink timing offset of two cells in which the first and the second terminal 102A, 102B are located, and the transmitter 222A is further configured to communicate the received measured cellular downlink timing offset of the two cells to another node B 104B via a node B-to-node B interface 230.

In an embodiment, the transmitter 222A is further configured to transmit an uplink reference signal allocated to a first terminal to a neighboring node B 104B via the node B-to-node B interface 230 when the cellular uplink reference signal is used for initial synchronization of the device-to-device communication connection and the paired terminals 102A, 102B are located in two neighboring cells.

In an embodiment, a D2D communication synchronization mechanism is proposed, using well-established cellular downlink synchronization as the timing reference for D2D communication. As a prerequisite, the radio frame structure used for D2D communication may have certain commonality with the frame structure of the cellular system to simplify the terminal implementation and as well the D2D synchronization. For instance, in an embodiment, if a cellular system is an OFDM (orthogonal frequency division multiplexing) based system like 3GPP LTE, the same OFDM symbol duration as defined in the cellular system is applied to D2D communication as well. In an embodiment, the length or integer multiple length of a radio frame and a sub-frame/slot for D2D communication is the same as those of the cellular system.

Detailed exemplary embodiments are presented in the following. It should be noted that the embodiments related to initializing and maintaining timing control loops are mainly focused on such D2D cases where the receiving D2D terminal receives simultaneously on multiple communication links. Embodiments related to the reference signal transmission are valid for all D2D cases within the scope of the invention defined above.

Initial Synchronization of D2D Communication:

In an embodiment, for initial synchronization of D2D communication, a receiving D2D UE measures the time difference between the received reference signal from a transmitting D2D terminal and a cellular downlink synchronization reference (e.g. the well-established and maintained downlink sub-frame and the radio frame timing of an LTE cellular system). The measured time difference is communicated to the transmitting D2D UE to adjust its timing of D2D transmission and thus to keep the timing alignment of the received D2D signal and the cellular downlink signal at the receiving D2D UE.

In an embodiment, a dedicated reference signal and an initial transmission power are allocated and informed to the paired D2D UEs by the node B of a cellular system when the D2D UEs are paired. The same reference signal may be used for both directions of the D2D communication if the D2D UEs are located in the same cellular cell. In an embodiment, the length, bandwidth and allowed maximum transmission power of the reference signal are designed to meet the requirement of the D2D communication range and the required timing accuracy. Reuse of the same reference signal for other paired D2D UEs may take into account the location of the paired D2D UEs (if the location information of the terminals is available at the node B) as well as the D2D communication range to avoid interference. Considering the reference signal is only used for initial synchronization of D2D communication, the same reference signal can be reallocated to the paired D2D UEs in any location beyond a certain time interval.

In an embodiment, a cellular uplink reference signal (e.g. sounding reference signal in LTE) can be used for D2D initial synchronization. In this alternative, the corresponding reference signal should be informed to the peer D2D UE by the node B when the D2D UEs are paired.

In practice, the D2D data transmission can only start after the initial synchronization of D2D communication has been established, which means that the transmitting D2D UE should transmit the dedicated reference signal first. After obtaining time alignment (TA) information from the receiving D2D UE, the actual D2D data transmission can be started.

Considering the D2D UEs are in the vicinity of each other, the transmitting D2D UE can align the reference signal transmission timing with its received cellular downlink timing with a certain advanced offset on the basis of the cellular uplink transmission timing to speed up timing difference measurement if the dedicated reference signal is used. If the cellular uplink reference signal is used for D2D initial synchronization, it would be easier from the terminal implementation point of view just to transmit the reference signal as usual in the cellular system.

In an embodiment, after the receiving D2D UE detects the reference signal from the transmitting D2D UE, the initial TA value is calculated and transmitted to the transmitting D2D UE. In an embodiment, in the case where D2D communication utilizes the uplink resources of the cellular system, the cellular uplink TA value of the receiving D2D UE is added to the initial TA value to align the D2D communications as much as possible with the cellular uplink signals. In an embodiment, the initial TA value is transmitted via the cellular system, i.e. the receiving D2D UE transmits the initial TA information to the node B and then the node B forwards it to the transmitting D2D UE. In another embodiment, the initial TA value can also be transmitted via a D2D link using unsynchronized transmission containing a similar reference signal for timing estimation of that D2D link. In the case, where the reference signal is transmitted with an advanced offset, this transmission may be synchronized if the node B signals the cellular uplink transmission timing of the involved D2D UE e.g. in a D2D pairing command.

Maintaining D2D Link Synchronization:

In an embodiment, to maintain D2D link synchronization, the receiving D2D UE performs a timing alignment measurement periodically to measure the timing difference of the received D2D signal and the cellular downlink signal. The measurement result is communicated to the transmitting D2D UE to advance or postpone its D2D transmission timing and thus to maintain the timing alignment of the received D2D signal and the cellular downlink signal at the receiving D2D UE.

The maintenance of D2D synchronization requires a periodic D2D transmission. For the case that the D2D UE has no data to transmit for a predefined time period, the lost of D2D synchronization may be informed to the node B, after which the initial D2D synchronization procedure needs to be applied in order to restart the D2D communication.

In an embodiment, TA information for maintaining D2D link synchronization is transmitted via the D2D link directly from the receiving D2D UE to the transmitting D2D UE. The TA information transmission can also be used for TA measurement in the other direction in case of an asymmetric D2D communication.

Supporting D2D Communication of UEs having Cellular Connection Via Different Node Bs:

In an embodiment, to support D2D communication of the UEs that are having a cellular connection via different node Bs, the following inter-node B communication may be supported to facilitate timing control and reference signal management.

In the case of a cellular network without inter-cell synchronization, one of the D2D UEs can be configured to measure the cellular downlink timing offset of two neighbouring cells and to take the measured timing offset into account when sending a reference signal to set up initial synchronization for D2D communication.

In an embodiment, the measured cellular downlink timing offset of two cells in which the paired D2D UEs are located can be reported to the node B and communicated to another node B via a node B-to-node B interface. The timing offset can be used either to align the D2D transmission timing in one direction with the other direction or to facilitate the node Bs′ resource allocation for D2D communication to reduce the possible interference of D2D and cellular communications.

In an embodiment, if the cellular uplink reference signal is used for D2D initial synchronization and the paired D2D UEs are located in two neighbouring cells, the UE's uplink reference signal allocated by its node B may be exchanged via the node B-to-node B interface to make it known to the peer D2D UE.

In an embodiment, if the dedicated reference signal is used for D2D initial synchronization, allocation of the reference signal may be coordinated within neighbouring node Bs to avoid the interference of reference signal transmission. In an embodiment, a non-overlapping reference signal pool can be used for each node B within its neighbourhood. Thus, the inter-node B communication is only needed to exchange the allocated reference signal to the paired D2D UEs if they are located in different cellular cells. No additional inter-NB coordination is needed for reference signal allocation.

Using well-established cellular downlink synchronization as the basis of D2D link synchronization simplifies the synchronization setup and maintenance of D2D links. In addition, timing alignment of the received D2D signal and the cellular downlink signal will facilitate the simultaneous multiple D2D communication when one D2D UE has multiple D2D links towards several D2D UEs. Thus, the D2D signals from different D2D UEs are timing synchronized at the single receiving UE to allow time domain multiplexing of D2D signals from different D2D UEs more efficiently.

The above exemplary embodiments related to initializing and maintaining timing control loops are focused on such D2D cases where the receiving D2D UE receives simultaneously on multiple communication links, e.g. multiple D2D signals, or alternatively, a D2D signal and a downlink cellular signal when D2D communication takes place on cellular downlink resources.

In an embodiment, the D2D synchronization mechanism makes all D2D links within one cell/node B quasi-synchronized (within the accuracy of the maximum propagation delay), which may ease the interference coordination in frequency domain between D2D links.

FIG. 3 shows a messaging diagram illustrating an exemplary messaging event according to an embodiment of the invention. More precisely, FIG. 3 illustrates an example of an initial D2D synchronization procedure. Only one direction of D2D synchronization from the UE_A (102A) to the UE_B (102B) is depicted in FIG. 3. The other direction synchronization follows the same procedure using the same reference signal that is broadcasted in a different resource (different frequency band or different time slot).

In 300, the cellular downlink transmission is synchronized in the UEs 102A, 102B. In 302, a pairing decision of the UE_A and the UE_B for a direct D2D communication is made in the base station 104. In 303 and 304, the base station transmits a D2D pairing command (e.g. reference signal, D2D resource allocation, etc.) to the UE_A and the UE_B, respectively. In 305, the UE_A broadcasts a reference signal in its allocated resource to the UE_B. In 306, the UE_B measures a time difference of the received reference signal from the UE_A and the start of a cellular downlink radio frame. In 307, the UE_B transmits an initial D2D synchronization command (e.g. initial TA value, UE_A etc.) to the base station 104. In 308, the base station 104 transmits the initial D2D synchronization command (e.g. initial TA value, UE_B etc.) to the UE_B.

In an embodiment, in the case where the transmitting D2D UE uses an advanced offset in the reference signal transmission timing, the uplink TA value is used to compensate for the propagation delay on the cellular downlink, thus allowing the reference signal to be transmitted at a time offset that is constant to the base station downlink transmission, irrespective of the transmitting D2D UE position in the cell. Thus, the measured timing difference of the received signal and the cellular downlink timing reference can be directly related to the propagation delay between the D2D UEs.

In an embodiment, in the case where both D2D UEs are in the same cell and the base station signals the cellular uplink transmission timing of the involved D2D UE in the D2D pairing command, the receiving D2D UE can calculate a proper timing for its own transmission to the other D2D UE. In other words, the synchronization is also obtained for the reverse D2D link, and the initial TA command can be transmitted on the synchronized D2D link.

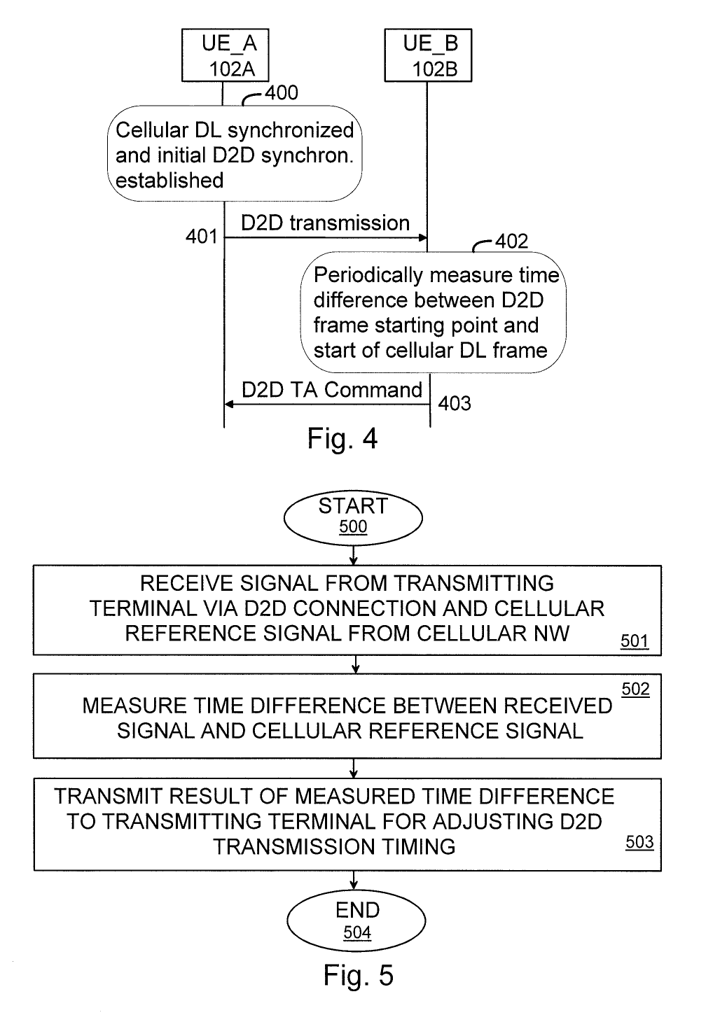

FIG. 4 shows another messaging diagram illustrating another exemplary event according to an embodiment of the invention. More precisely, FIG. 4 illustrates an example of D2D synchronization maintenance. Again, only one direction synchronization from the UE_A to the UE_B is illustrated in FIG. 4.

In 400, cellular downlink transmission is synchronized and initial D2D synchronization is established in the UE_A. In 401, D2D transmission from the UE_A to the UE_B is performed. In 402, the UE_B measures a time difference between a received D2D frame starting point and the start of a cellular downlink radio frame periodically. In 403, the UE_B transmits a D2D TA command (e.g. TA value, UE_B etc.) to the UE_A. Based on the transmitted D2D TA command, the UE_A can then adjust (e.g. either advance or postpone) its D2D transmission timing.

FIGS. 5, 6 and 7 show examples of methods according to embodiments of the invention.

FIG. 5 illustrates an example of a method according to an embodiment. The method starts in 500. In 501, an apparatus, e.g. in a UE, receives a signal from a transmitting terminal via a direct device-to-device communication connection, and a cellular reference signal from a cellular network. In 502, a time difference between the received signal and the cellular reference signal is measured. In 503, the result of the measured time difference is transmitted to the transmitting terminal for adjusting the device-to-device transmission timing of the transmitting terminal. The method ends in 504.

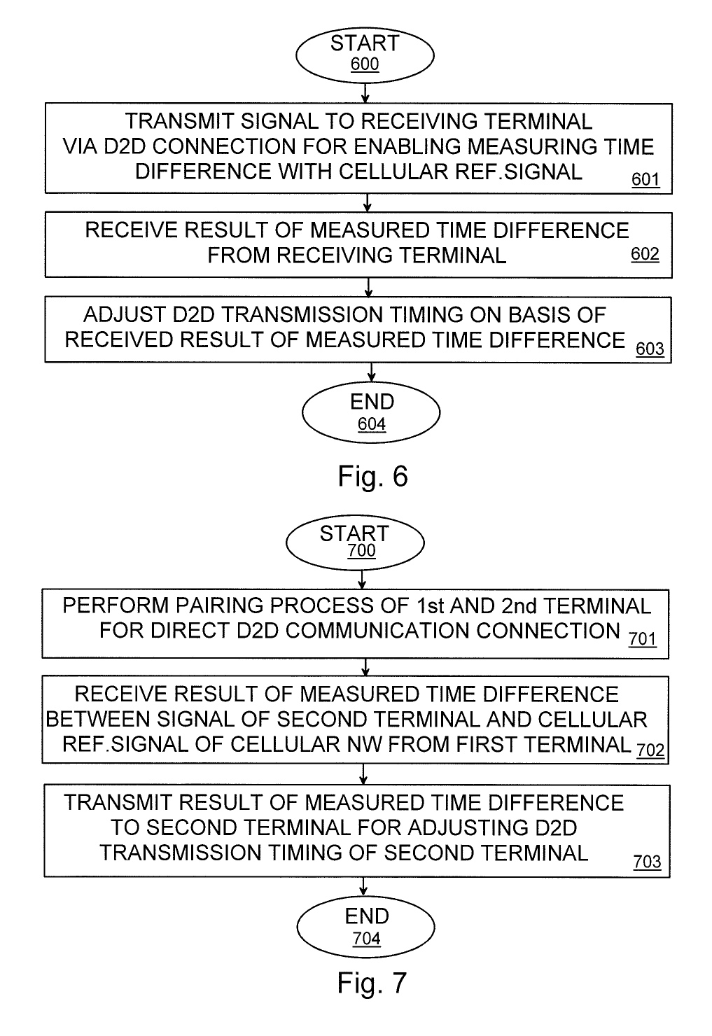

FIG. 6 illustrates an example of a method according to an embodiment. The method starts in 600. In 601, an apparatus, e.g. in a UE, transmits a signal to a receiving terminal via a direct device-to-device communication connection for enabling the receiving terminal to measure a time difference between the transmitted signal and a cellular reference signal of a cellular network. In 602, the result of the measured time difference is received from the receiving terminal. In 603, the device-to-device transmission timing of the apparatus is adjusted on the basis of the received result of the measured time difference. The method ends in 604.

FIG. 7 illustrates an example of a method according to an embodiment. The method starts in 700. In 701, an apparatus, e.g. in a base station, performs a pairing process of a first and a second terminal for a direct D2D communication connection. In 702, a result of a measured time difference between a signal of the second terminal and a cellular reference signal of the cellular network is received from the first terminal. In 703, the received result of the measured time difference is transmitted to the second terminal for enabling the second terminal to adjust its D2D transmission timing. The method ends in 704.

It will be obvious to a person skilled in the art that as technology advances, the inventive concept can be implemented in various ways. The invention and its embodiments are not limited to the examples described above but may vary within the scope of the claims.

1. An apparatus comprising:
a receiver configured to receive a signal from a transmitting terminal via a direct device-to-device communication connection, and to receive a cellular reference signal from a cellular network;
a processor configured to measure a time difference between the received signal and the cellular reference signal; and
a transmitter configured to transmit the result of the measured time difference to the transmitting terminal for adjusting device-to-device transmission timing of the transmitting terminal.

2. The apparatus of claim 1, wherein the processor is configured to control initial link synchronization of the direct device-to-device communication connection to the transmitting terminal on the basis of the measured time difference between the received signal from transmitting terminal and the cellular reference signal.

3. The apparatus of claim 2, wherein the cellular reference signal is a cellular downlink reference signal that is used as a cellular synchronization reference signal for the initial synchronization of the direct device-to-device communication connection.

4. The apparatus of claim 2, wherein the received signal from the transmitting terminal is a dedicated reference signal that is allocated to the transmitting terminal and used for the initial synchronization of the direct device-to-device communication connection.

5. The apparatus of claim 2, wherein the received signal from the transmitting terminal is a cellular uplink reference signal.

6. The apparatus of claim 1, wherein the processor is configured to maintain link synchronization of the direct device-to-device communication connection to the transmitting terminal on the basis of the measured time difference between the received signal from the transmitting terminal and the cellular reference signal.

7. The apparatus of claim 6, wherein the received signal from the transmitting terminal is any device-to-device signal from the transmitting terminal and wherein the processor is configured to periodically measure the time difference between the received device-to-device signal and the cellular reference signal.

8. An apparatus comprising:
a transmitter configured to transmit a signal to a receiving terminal via a direct device-to-device communication connection for enabling the receiving terminal to measure a time difference between the transmitted signal and a cellular reference signal of a cellular network;
a receiver configured to receive the result of the measured time difference from the receiving terminal; and
a processor configured to adjust device-to-device transmission timing of the apparatus on the basis of the received result of the measured time difference.

9. The apparatus of claim 8, wherein the receiver is further configured to receive the result of the measured time difference from the receiving terminal for maintaining link synchronization of the direct device-to-device communication connection, and the processor is configured to adjust the device-to-device transmission timing on the basis of the received result of the measured time difference.

10. The apparatus of claim 8, wherein the processor is further configured to measure a cellular downlink timing offset of two neighbouring cells, and to take the measured cellular downlink timing offset into account when sending the signal to the receiving terminal.

11. A method comprising:
receiving a signal from a transmitting terminal via a direct device-to-device communication connection, and receiving a cellular reference signal from a cellular network;
measuring a time difference between the received signal and the cellular reference signal; and
transmitting the result of the measured time difference to the transmitting terminal for adjusting device-to-device transmission timing of the transmitting terminal.

12. The method of claim 11, the method further comprising controlling initial link synchronization of the direct device-to-device communication connection to the transmitting terminal on the basis of the measured time difference between the received signal from the transmitting terminal and the cellular reference signal.

13. The method of claim 12, the method further comprising using a cellular downlink reference signal as a cellular synchronization reference signal for the initial synchronization of the direct device-to-device communication connection.

14. The method of claim 12, wherein the received signal from the transmitting terminal is a dedicated reference signal allocated to the transmitting terminal and used for the initial synchronization of the direct device-to-device communication connection.

15. The method of claim 12, wherein the received signal from the transmitting terminal is a cellular uplink reference signal.

16. The method of claim 11, the method further comprising maintaining link synchronization of the direct device-to-device communication connection to the transmitting terminal on the basis of the measured time difference between the received signal from the transmitting terminal and the cellular reference signal.

17. The method of claim 16, wherein the received signal from the transmitting terminal is any device-to-device signal from the transmitting terminal, the method further comprising: measuring the time difference between the received device-to-device signal and the cellular reference signal.

18. A method comprising:
transmitting a signal to a receiving terminal via a direct device-to-device communication connection for enabling the receiving terminal to measure a time difference between the transmitted signal and a cellular reference signal of a cellular network;
receiving the result of the measured time difference from the receiving terminal; and
adjusting device-to-device transmission timing of the apparatus on the basis of the received result of the measured time difference.

19. The method of claim 18, the method further comprising: receiving the result of the measured time difference from the receiving terminal for maintaining link synchronization of the direct device-to-device communication connection, and adjusting the device-to-device transmission timing on the basis of the received result of the measured time difference.

20. An article of manufacture, comprising a computer readable medium and embodying program instructions thereon, executable by a computer operably coupled to a memory and, when executed by the computer, carry out the functions of:
receiving a signal from a transmitting terminal via a direct device-to-device communication connection, and receiving a cellular reference signal from a cellular network;
measuring a time difference between the received signal and the cellular reference signal; and
transmitting the result of the measured time difference to the transmitting terminal for adjusting device-to-device transmission timing of the transmitting terminal.

21. The article of manufacture of claim 20, the computer readable medium including at least one of the following media: a computer readable medium, a program storage medium, a record medium, a computer readable memory, a computer readable software distribution package, a computer readable signal, a computer readable telecommunication signal, and a computer readable compressed software package.

22. An apparatus comprising:
a processor configured to perform a pairing process of a first terminal and a second terminal for a direct device-to-device communication connection;
a receiver configured to receive from the first terminal a result of a measured time difference between a signal from the second terminal and a cellular reference signal from a cellular network; and
a transmitter configured to transmit the result of the measured time difference to the second terminal for adjusting device-to-device transmission timing of the second terminal.

23. The apparatus of claim 22, wherein the receiver is further configured to receive a measured cellular downlink timing offset of two cells in which the first and the second terminal are located, and the transmitter is further configured to communicate the received measured cellular downlink timing offset of the two cells to another node B via a node B-to-node B interface.

24. The apparatus of claim 22, wherein the transmitter is further configured to transmit an uplink reference signal allocated to the first terminal to a neighboring node B via a node B-to-node B interface when the cellular uplink reference signal is used for initial synchronization of the device-to-device communication connection and the paired terminals are located in two neighboring cells.
